(19) United States
(12) Patent Application Publication
(10) Pub. No.: US 2012/0049011 A1
(43) Pub. Date: Mar. 1, 2012

(54) CABLE MANAGEMENT APPARATUS

(75) Inventor: LEI LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/898,650

(22) Filed: Oct. 5, 2010

(30) Foreign Application Priority Data
Aug. 27, 2010 (CN) 201010264752.0

(51) Int. Cl. F16L 3/00

(52) U.S. Cl. 248/68.1

(57) ABSTRACT

A cable management apparatus for binding cables includes a bracket and a clamp adjustably mounted on the bracket. The bracket includes two posts. The clamp includes a support plate, two limiting members and latching members. The support plate defines two through holes through which the posts of the bracket extend. The limiting members and the latching members are respectively adjacent to each of the two through holes. A receiving space for accommodating the cables is defined among the support plate and the limiting members. The posts extend through the through holes and adjustably engage with the corresponding latching members to adjustably fasten the clamp to the bracket.

### BACKGROUND

1. Technical Field

The present disclosure relates to management apparatuses, and more particularly to a cable management apparatus.

2. Description of Related Art

Generally, in computers or servers, cable management apparatuses are used to bind cables used in the computers or servers. However, ordinarily, the cable management apparatus is hard to adjust, so the cable management apparatus generally needs to be replaced when the position of the cables needs to be adjusted, which is inconvenient and costly.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a management apparatus for cables.

FIG. 2 is an assembled, isometric view of the management apparatus of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

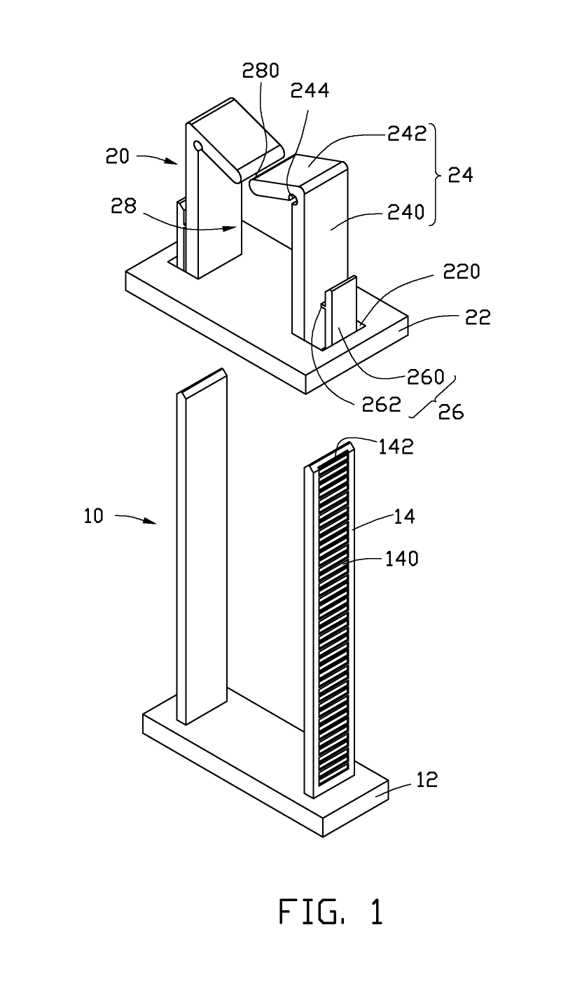

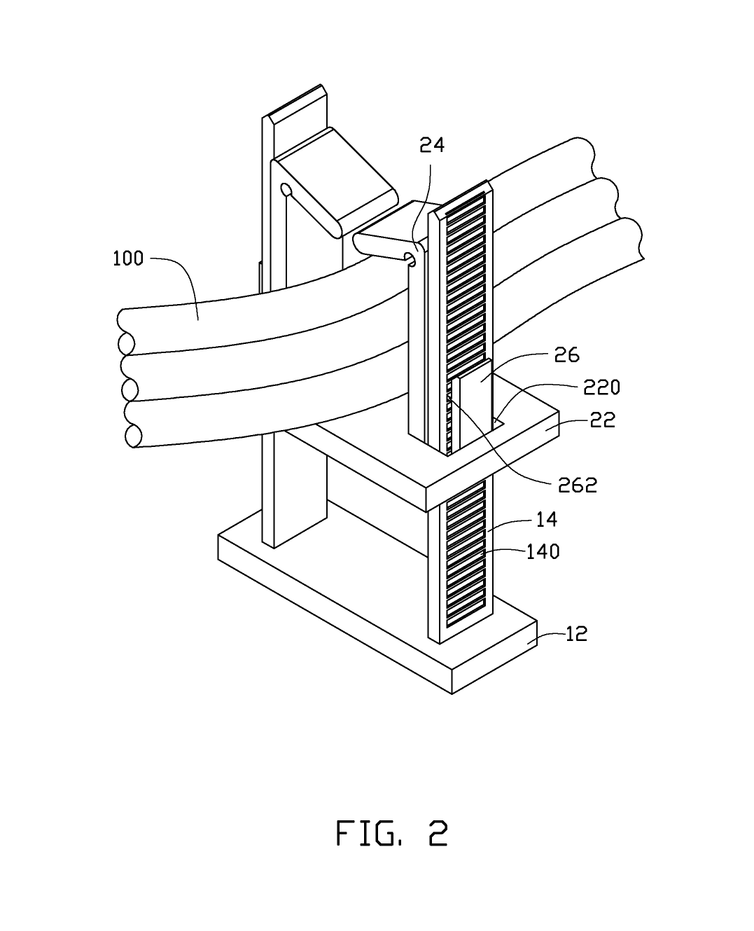

Referring to FIG. 1 and FIG. 2, an exemplary embodiment of a cable management apparatus used to bind cables 100 includes a bracket 10, and a clamp 20 mounted to the bracket 10.

The bracket 10 includes a base plate 12, and two posts 14 perpendicularly extending up from the opposite ends of the base plate 12. The posts 14 are substantially plate-shaped and substantially parallel to each other. A lateral surface facing outside of each post 14 defines a number of latching slots 140. The top end of each post 14 forms a tapered guide portion 142.

The clamp 20 includes a substantially rectangular supporting plate 22, two substantially L-shaped limiting members 24, and two latching members 26. The support plate 22 defines two rectangular through holes 220 in opposite ends thereof, for the posts 14 of the bracket 10 to extend through. The limiting members 24 protrude up from first sides, bounding the through holes 220 substantially adjacent to the center of the support plate 22, thereby forming a receiving space 28 among the support plate 22 and the limiting members 24, to bind the cables 100. The latching members 26 protrude up from second sides bounding the through holes 220 opposite to the first sides.

Each limiting member 24 includes a first limiting plate 240 perpendicularly protruding up from the first side of a corresponding through hole 220 of the support plate 22, and a second limiting plate 242 slantingly extending from a distal end of the second limiting plate 242 towards the other limiting member 24. An angle between the first limiting plate 240 and the second limiting plate 242 of each limiting member 24 is less than 90 degrees. A substantially C-shaped slot 244 is defined in a conjunction between the first limiting plate 240 and the second limiting plate 242 of each limiting member 24, thereby the second limiting plate 242 can easily rotate relative to the first limiting plate 242 about the conjunction. An opening 280 communicating with the receiving space 28 is formed between the second limiting plates 242.

Each latching member 26 includes a latching plate 260 perpendicularly protruding up from the second side of a corresponding through hole 220 of the support member 22, and is substantially parallel to the first limiting member 240. A latch 262 protrudes from a side surface of the latching plate 260, opposing the first limiting member 240. In this embodiment, the limiting members 24 and the latching members 26 are made of elastic material, such as plastic.

In assembly, the latching members 26 are deformed to move away from the limiting members 24, and the posts 14 of the bracket 10 extend through the corresponding through holes 220 of the clamp 20. After the clamp 20 moves to a predetermined height of the posts 14 of the bracket 10, the latching members 26 are released to restore. The latches 262 of the latching members 26 engage in the corresponding latching slots 140 of the posts 14 to fasten the clamp 20 to the bracket 10. The tapered guide portions 142 can guide the posts 14 to conveniently extend through the corresponding through holes 220.

In use, the cables 100 enter the receiving space 28 through the opening 280 of the clamp 20 by rotating the second limiting plates 242 down towards the support plate 22, or directly enter the receiving space 28. When the position of the cables 100 needs to be changed, the latching members 26 are deformed to move away from the limiting members 24, and the clamp 20 is slid along the posts 14, then the latching members 26 are released, with the latches 262 engaging in another two corresponding latching slots 140 of the posts 14. Thereby, the position of the cables 100 is changed, which is very convenient.

It is to be understood, however, that even though numerous characteristics and advantages of the embodiments have been set forth in the foregoing description, together with details of the structure and function of the embodiments, the present disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A cable management apparatus for binding cables, the cable management apparatus comprising:
a bracket comprising two posts; and
a clamp comprising a support plate, the support plate defining two through holes therein, the clamp further comprising two limiting members and two latching members respectively adjacent to each of the two through holes;
wherein a receiving space is defined among the support plate and the limiting members for accommodating the cables, the posts of the bracket extend through the through holes of the clamp and adjustably engage with the latching members to adjustably fasten the clamp to the bracket.

2. The cable management apparatus of claim 1, wherein the bracket further comprises a base plate, wherein the posts substantially perpendicularly extend from opposite ends of the base plate.

3. The cable management apparatus of claim 1, wherein each of the through holes of the clamp are substantially rectangular, the limiting members protrude from first sides bounding the through holes adjacent to a center of the support plate, and the latching members protrude from second sides bounding the through holes opposite to the first sides.

4. The cable management apparatus of claim 1, wherein each latching member comprises a latching plate perpendicularly protruding up from the support plate, substantially parallel to the limiting member, and a latch protruding from a side surface of the latching plate opposing the corresponding limiting member, each of the posts is substantially plate-shaped and defines a plurality of latching slots to selectively engage with the corresponding latch.

5. The cable management apparatus of claim 4, wherein the latching members are made of elastic material.

6. The cable management apparatus of claim 1 wherein each limiting member comprises a first limiting plate perpendicularly protruding from the support plate, and a second limiting plate slantingly extending from a distal end of the first limiting plate towards the other limiting member, an opening communicating with the receiving space is formed between the second limiting plates.

7. The cable management apparatus of claim 6, wherein a substantially C-shaped slot is defined in a conjunction of the first limiting plate and the second limiting plate of each limiting member, thereby the second limiting plate is operable to rotate relative to the first limiting plate about the conjunction.
